(19) United States
(12) Patent Application Publication
(10) Pub. No.: US 2025/0334180 A1
(43) Pub. Date: Oct. 30, 2025

(54) Combined Multi-Lip Seal

(71) Applicant: Global Manufacturing Holdings LLC, Lisle, IL (US)

(72) Inventor: Qingsong Chen, Yandian Town (CN)

(21) Appl. No.: 19/189,950

(22) Filed: Apr. 25, 2025

Related U.S. Application Data
(60) Provisional application No. 63/639,423, filed on Apr. 26, 2024.

(51) Int. Cl. F16J 15/3232

(52) U.S. Cl. CPC F16J 15/3232

(57) ABSTRACT

A seal assembly is provided, having a skeleton or housing having a first opening and a second opening having centers aligned along an axis; a first seal ring carried within the housing and aligned along the axis between the first and second opening; a second seal ring carried within the housing and aligned along the axis and located between the first seal ring and the second opening; and a third seal ring mounted to the second opening. The first and second seal rings can include seal lips extended in a first direction toward the first opening. The third seal ring can include a seal lip extended in a second direction opposite the first direction. The first and second seal rings can be composed of polytetrafluoroethylene (PTFE) and the third seal ring can be composed of rubber.

This Application claims the benefit of U.S. Provisional Application 63/639,423, filed Apr. 26, 2024.

### BACKGROUND

The invention relates to the technical field of seals, particularly oil seals and/or grease seals. In industrial production equipment, oil seals and grease seals are one of the most widely used sealing elements. Oil seals and grease seals can isolate and seal lubricating oil or grease in a predetermined space to prevent lubricating oil or grease from leaking out of the predetermined space. Normally, rotating parts pass through the oil seal or grease seal. The inner circumferential surface of the sealing lip of the oil seal or grease seal contacts the outer circumferential surface of the rotating part to form a sealing surface. There is sliding friction between the sealing lip and the rotating part, and a good sealing state is maintained between the sealing lip of the oil seal or grease seal and the rotating part.

### SUMMARY

This exemplary embodiment of the invention provides a seal assembly, for sealing a rotating shaft. The seal assembly is useful for sealing oil, grease or other liquids or materials from moving through the seal along the rotating shaft. The seal assembly can be sealingly fitted to a pump housing or an axle housing for example, and a rotating pump shaft extends into the pump housing or axle housing through the seal assembly to be effectively sealed to the pump housing or axle housing.

The assembly is generally cylindrical shaped and seals against a rotating shaft. For example, the seal assembly can be sealingly fixed in or on a pump housing or axle housing, wherein the rotating input shaft of the pump or axle, that extends into the pump housing or axle housing is sealed to the pump housing or axle housing by the seal assembly. Particularly, the embodiment can be a combined multi-lip polytetrafluoroethylene (“PTFE”) seal.

The embodiment comprises an outward sealing ring, preferably a rubber sealing ring, a metal skeleton, an internal primary sealing ring with a primary lip and a secondary sealing ring with a secondary lip. The outward rubber sealing ring is provided with an outward directed sealing lip.

The metal skeleton is comprised of a first metal skeleton portion and a second metal skeleton portion, each preferably composed of stainless steel. The first and second metal skeleton portions are cylindrical with an edge cross-section being substantially L-shaped. The first and second metal skeletons thus each have an annular rim portion and a contiguous annular ring portion. The ring portion of the first metal skeleton portion is bonded to the outward rubber sealing ring. Bonding can be by adhesive, a mechanical engagement, welded or other means of bonding rubber to metal. The internal primary sealing ring and the internal secondary sealing ring are preferably composed of PTFE.

A fixed end portion of the primary sealing ring is flat and backed by a first annular pad, preferably an annular rubber pad and a contiguous free end portion is shaped as a truncated cone but with a curved sidewall. The curvature of the sidewall can be semi-circular in profile. The lip of the outward rubber sealing ring extends in the opposite direction from the extension of the primary lip of the free end portion of the primary sealing ring. The rim portion of the second metal skeleton portion is bonded to the rim portion of the first metal skeleton portion, and the ring portion of the second metal skeleton portion is bonded to the fixed end portion of the primary sealing ring. The bonding can be by adhesive, a mechanical friction fit, welding or other means of bonding the materials.

The internal secondary sealing ring includes a fixed end portion and a contiguous free end portion. The fixed end portion is flat and separated from one end of the first metal skeleton portion by a second annular pad, preferably a second annular rubber pad. The internal secondary sealing ring is held between the first and second annular rubber pads. The free end portion is shaped as a truncated cone but with a curved sidewall. The curvature of the sidewall can be semi-circular in profile. The sidewall can include four convex ribs. The free end portion of the internal secondary sealing ring extends in the opposite directions from the sealing lip of the outward rubber sealing ring.

The free end portion of the primary sealing ring can be provided with a surrounding spring ring to maintain close contact with a rotating shaft within the primary sealing ring.

The inner diameter of the internal primary sealing lip is smaller than the inner diameter of the secondary sealing lip.

The outward rubber sealing ring and first and second annular rubber pads can be made of hydrogenated nitrile rubber.

According to one embodiment, a seal assembly is provided, comprising: a housing having a first opening and a second opening having centers aligned along an axis; a first seal ring carried within the housing and aligned along the axis between the first and second opening; a second seal ring carried within the housing and aligned along the axis and located between the first seal ring and the second opening; and a third seal ring mounted to the second opening.

The first and second seal rings can include seal lips extended in a first direction toward the first opening. The third seal ring can include a seal lip extended in a second direction opposite the first direction. The first and second seal rings can be composed of polytetrafluoroethylene (PTFE) and the third seal ring can be composed of rubber.

The embodiment seal is not easy to deform, with excellent high and low temperature resistance, and low friction coefficient for use in extremely high speed and harsh environments or when there is a need to reduce the lip temperature.

Numerous other advantages and features of the present invention will become readily apparent from the following detailed description of the invention and the embodiments thereof, from the claims and from the accompanying drawings.

### BRIEF DESCRIPTION OF THE DRAWINGS

FIG. 1 is a perspective view of a seal assembly;

FIG. 2 is an exploded perspective view of the assembly of FIG. 1; and

FIG. 3 is a sectional view of the assembly, taken through plane 3-3 of FIG. 1.

### DETAILED DESCRIPTION

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

This application incorporates by reference U.S. Provisional Application 63/639,423, filed Apr. 26, 2024 in its entirety.

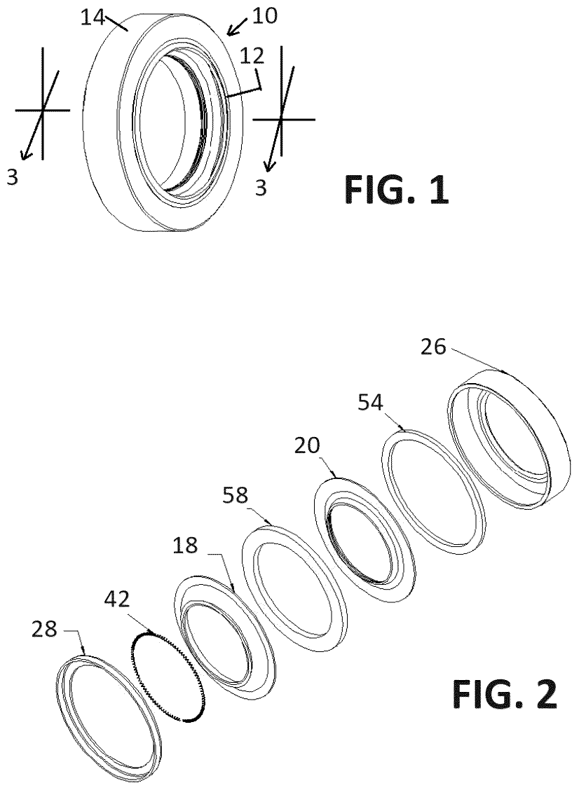

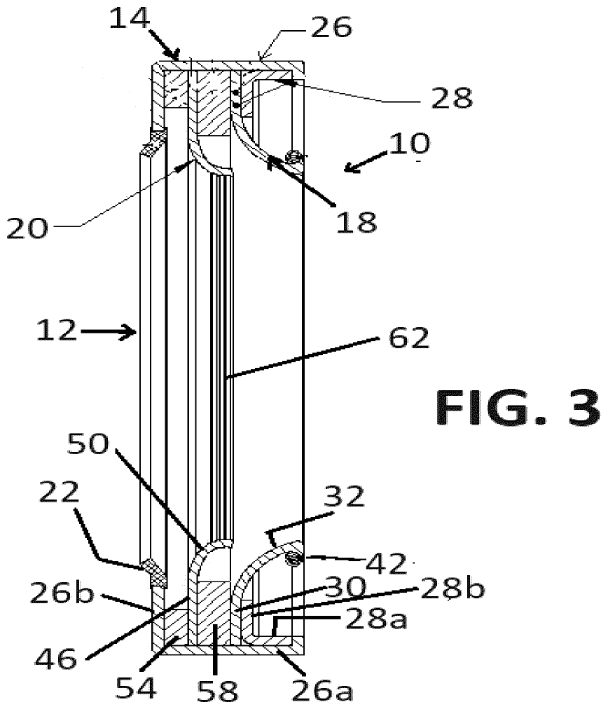

As shown in FIGS. 1-3, the embodiment of the invention is a seal assembly 10 comprised of an outward sealing ring, preferably an outward rubber sealing ring 12, a metal skeleton portion 14, an internal primary sealing ring 18 and an internal secondary sealing ring 20. The internal primary sealing ring and the internal secondary sealing ring can be composed of PTFE.

The outward rubber sealing ring 12 is provided with an outward sealing lip 22, and the outward sealing lip 22 has elastic characteristics, which can effectively block rain and sediment, and play a role in protecting the internal primary sealing ring 18 and the internal secondary sealing ring 20, and extend the service life of the seal assembly.

The metal skeleton portion includes a first metal skeleton portion 26 and a second metal skeleton portion 28. The first and second metal skeleton portions 26, 28 are configured as cylindrical housings. The first metal skeleton portion 26 and the second metal skeleton portion 28, viewed in cross-section at the edge, are L-shaped. Thus, the first metal skeleton portion 26 includes an annular rim portion 26a and a contiguous annular ring portion 26b. The second metal skeleton portion 28 includes an annular rim portion 28a and a contiguous annular ring portion 28b. One end of the first metal skeleton portion 26 is fitted around the outside perimeter of the outward rubber sealing ring 12, and at the other end, the rim portion 26a of the first metal skeleton portion is bonded to the rim portion 28a of the second metal skeleton portion 28.

The internal primary sealing ring 18 includes fixed end portion 30 and a contiguous free end portion 32. Fixed end portion 30 is annular and flat. Free end portion 32 is shaped as a truncated cone but with a curved sidewall. The curvature of the sidewall can be semi-circular in profile. A spring ring 42 is provided surrounding the free end portion 32 to maintain close sealing contact between the primary sealing ring and a rotating shaft extended through the assembly 10. The free end portion 32 of the internal primary sealing ring 18 and the outward sealing lip 22 extend in opposite directions, respectively.

The internal secondary sealing ring 20 includes fixed end portion 46 and a contiguous free end portion 50. Fixed end portion 46 is a flat and annular, and is fitted on opposite axial sides with first and second annular pads, preferably first and second annular rubber pads 54, 58. The free end portion 50 is shaped as a truncated cone but with a curved sidewall. The curvature of the sidewall can be semi-circular in profile. The free end portion 50 can be provided with four convex ribs 62 on an inside surface thereof. The free end portion 50 of the internal secondary sealing ring 20 and the sealing lip 22 of the outer auxiliary sealing ring 12 extend in opposite directions.

The rim portion 28a of the second metal skeleton portion 28 is bonded to the rim portion 26a of the first metal skeleton portion 26, and the ring portion 28b of the second metal skeleton portion 28 is bonded to the fixed end portion 30 of the internal primary sealing ring 18, further strengthening the rigidity of the seal, while blocking the pressure generated by the sealing medium. The fixed end portion 30 of the primary sealing ring 18 is held between the second annular rubber pad 58 and the ring portion 28b of the second metal skeleton portion 28. The axial end of the rim portion 26a of the first metal skeleton portion 26 is bent inward by 90° and wrapped outside the axial end of the rim portion 28a of the second metal skeleton portion 28 on an end of the seal assembly 10 opposite the outward sealing ring 12. The first metal skeleton portion 26 and the second metal skeleton portion 28 can be made of stainless-steel material.

The inner ring diameter of the internal primary sealing ring 18 and the internal secondary sealing ring 20 is less than the inner ring diameter of the outer secondary sealing ring 12. In other words, the internal primary sealing ring 18 and the internal secondary sealing ring 20 are interference fit designs with a rotating shaft. The sectional view of FIG. 3 shows the internal primary seal and the internal secondary seal in a relaxed state before being stretched open to sealingly fit over the rotating shaft.

The internal primary sealing ring 18 and the internal secondary sealing ring 20 can be made of PTFE material, which has excellent chemical resistance and high and low temperature resistance, self-lubricity and friction resistance. The rubber sealing ring 12 can be made of hydrogenated nitrile rubber.

From the foregoing, it will be observed that numerous variations and modifications may be effectuated without departing from the spirit and scope of the invention. It is to be understood that no limitation with respect to the specific apparatus illustrated herein is intended or should be inferred.

The invention claimed is:

1. A seal assembly, comprising:
a housing having a first opening and a second opening having centers aligned along an axis;
a first seal ring carried within the housing and aligned along the axis between the first and second opening;
a second seal ring carried within the housing and aligned along the axis and located between the first seal ring and the second opening; and
a third seal ring mounted to the second opening.

2. The seal assembly of claim 1, wherein the first and second seal rings include seal lips extended in a first direction toward the first opening.

3. The seal ring of claim 2, wherein the third seal ring includes a seal lip extended in a second direction opposite the first direction.

4. The seal ring of claim 1, wherein the first and second seal rings are composed of polytetrafluoroethylene (PTFE) and the third seal ring is composed of rubber.

5. A seal assembly, comprising:
an outward sealing ring;
a metal skeleton portion;
an internal primary sealing ring; and
an internal secondary sealing ring, the outward sealing ring is provided with an outward sealing lip, the outward sealing lip having elastic characteristics, wherein the metal skeleton portion includes a first metal skeleton portion and a second metal skeleton portion, the first and second metal skeleton portions are configured as cylindrical housings, wherein the first metal skeleton portion and the second metal skeleton portion, have L-shaped cross-sections, the first metal skeleton portion including an annular rim portion and a contiguous annular ring portion, the second metal skeleton portion including an annular rim portion and a contiguous annular ring portion, wherein one end of the first metal skeleton portion is fitted around the outside perimeter of the outward sealing ring, and at the other end, the rim portion of the first metal skeleton portion is bonded to the rim portion of the second metal skeleton portion.

6. The seal assembly according to claim 5, wherein the internal primary sealing ring includes a fixed end portion and a contiguous free end portion, wherein the fixed end portion is annular and flat and the free end portion is shaped as a truncated cone but with a curved sidewall.

7. The seal assembly according to claim 6, comprising a spring ring surrounding the free end portion of the internal primary sealing ring to maintain close sealing contact between the primary sealing ring and a rotating shaft extended through the assembly, wherein the free end portion of the internal primary sealing ring and the outward sealing lip extend in opposite directions, respectively.

8. The seal assembly according to claim 7, wherein the internal secondary sealing ring includes a fixed end portion and a contiguous free end portion, wherein the fixed end portion is flat and annular, and is fitted on opposite axial sides with first and second annular pads.

9. The seal assembly according to claim 8, wherein the free end portion of the internal secondary sealing ring is shaped as a truncated cone but with a curved sidewall.

10. The seal assembly according to claim 9, wherein a curvature of the sidewall free end portion of the internal secondary sealing ring is semi-circular in profile.

11. The seal assembly according to claim 10, wherein free end portion of the internal secondary sealing ring is provided with four convex ribs on an inside surface thereof.

12. The seal assembly according to claim 11, wherein free end portion of the internal secondary sealing ring and the sealing lip of the outer auxiliary sealing ring extend in opposite directions.

13. The seal assembly according to claim 12, wherein rim portion of the second metal skeleton portion is bonded to the rim portion of the first metal skeleton portion, and the ring portion of the second metal skeleton portion is bonded to the fixed end portion of the internal primary sealing ring.

14. The seal assembly according to claim 13, wherein the fixed end portion of the primary sealing ring is held between the second annular pad and the ring portion of the second metal skeleton portion.

15. The seal assembly according to claim 14, wherein axial end of the rim portion of the first metal skeleton portion is bent inward by 90° and wrapped outside the axial end of the rim portion of the second metal skeleton portion on an end of the seal assembly opposite the outward sealing ring.

16. The seal assembly according to claim 15, wherein first metal skeleton portion and the second metal skeleton portion are composed of stainless-steel.

17. The seal assembly according to claim 16, wherein inner ring diameter of the internal primary sealing ring and the internal secondary sealing ring is less than the inner ring diameter of the outer secondary sealing ring.

18. The seal assembly according to claim 17, wherein the internal primary sealing ring and the internal secondary sealing ring are composed of PTFE.
